(19) United States
(12) Patent Application Publication
(10) Pub. No.: US 2021/0022323 A1
(43) Pub. Date: Jan. 28, 2021

(54) CIRCULATING WATER PURIFICATION SYSTEM FOR AQUACULTURE BREEDING

(71) Applicant: Xiao Jun ZHANG, Guizhou (CN)

(72) Inventor: Xiao Jun ZHANG, Guizhou (CN)

(21) Appl. No.: 16/522,681

(22) Filed: Jul. 26, 2019

(51) Int. Cl. A01K 63/04; A01K 61/10; A01K 61/59; A01K 61/80; C02F 3/00; C02F 3/02

(52) U.S. Cl. CPC A01K 63/042; A01K 63/045; A01K 63/047; A01K 61/10; C02F 2301/046; A01K 61/80; C02F 3/006; C02F 3/02; A01K 2227/40; A01K 61/59

(57) ABSTRACT

A circulating water purification system for aquaculture breeding, including a feeding machine, a growing pond, a water purification and separation system, and a recycling device, where the feeding machine for feeding fry to the growing pond is disposed outside the growing pond, the upper part of the growing pond is provided with a water-level safety line, the bottom of the growing pond is conical, and a mesh for filtering solids from liquids are mounted at the bottom of the growing pond; the bottom of the growing pond is connected to the water purification and separation system through a first discharge pipe; the water purification and separation system are provided with a feed pump, and pumps water to the growing pond through the feed pump; and the water purification and separation system are connected to the recycling device.

### BACKGROUND OF THE INVENTION

The utility model relates to the technical field of aquacultures, especially to an circulating water purification system for aquaculture breeding.

At present, aquaculture is carried out by artificially feeding fry to aquaculture ponds, and the aquaculture ponds are aerated by an oxygen generator. A large amount of solid sediments such as faces and residual feeds produced during breeding are not treated in time, and would be easily fermented into soluble organic matter, ammonia nitrogen and other substances after long time. Moreover, water in the aquaculture pond is not fully cleanse, resulting in odour and deterioration of water quality.

This deterioration of water quality not only will be harmful to the environment when discharge, it will also affect the production yield.

### BRIEF SUMMARY OF THE INVENTION

The utility model provides a circulating water purification system for aquaculture, which arms to filter solid sediments generated in the aquaculture process, and purify the aquaculture water by treating it to meet the standard for re-circulating water supply, thereby improving the breeding survival rate.

The utility model is implemented by the following technical solution: a circulating water purification system for aquaculture, including a feeding machine, a growing pond, a water purification and separation system, and a recycling device, where the feeding machine for feeding fry to the growing pond is dispose outside the growing pond, the upper part of the growing pond is provided with a water-level safety line, an anti-blocking aeration device is mounted in the growing pond, the bottom of the growing pond is conical, and a mesh for filtering solids from liquids are mounted at the bottom of the growing pond; the bottom of the growing pond is connected to the water purification and separation system through a first discharge pipe; the water purification and separation system are provided with a feed pump; the feed pump is connected to the water purification and separation system through a pipeline to pump water to the growing pond to form circulating water, and the water purification and separation system are connected to the recycling device.

Further, the water purification and separation system includes a collection pond, a buffer pond, a sedimentation pond, a water purifier, and a water quality monitoring device; the bottoms of the collection pond, buffer pond, and sedimentation pond are all conical; the bottom of said collection pond is connected to the buffer pond through a sewage pipe, the bottom of the buffer pond is connected to the sedimentation pond through a sewage pipe, and the bottom of the sedimentation pond is connected to the recycling device through a discharge pipe; the collection pond is connected to the first discharge pipe at the bottom of the growing pond; the water quality monitoring device is mounted outside the collection pond; the collection pond is connected to the water quality monitoring device; the water purifier is mounted at one side of the water quality monitoring device; and the water purifier is connected to the collection pond, buffer pond, sedimentation pond and recycling device.

Further, the water quality monitoring system includes a water quality, monitor and detecting device, and a water quality regulating compartment; this water quality detection device is mounted in the collection pond; the water quality regulating compartment is dispose at one side of the water quality monitor; the water quality monitor is connected to the water quality detection element and the water quality regulating compartment; and the water quality regulating compartment is connected to the collection pond through a pipeline, and inputs a conditioning agent to the collection pond.

Further, a second pump and a third pump are dispose outside the water purifier; the second pump is connected to the buffering pond to pump water to the water purifier for purification; the third pump is connected to the sedimentation pond to pump water to the water purifier for purification; water purified by the water purifier is convey to the collection pond through a bottom pipeline; and a foam-like separated matter generated in the purification of the water purifier is convey to the recycling device through a top pipeline.

Further, the anti-blocking aeration device include an anti-blocking device, an aeration pump, and a safety pipe; the anti-blocking device is dispose inside the growing pond, and the aeration pump is located outside the growing pond; one end of the aeration pump is connected to the growing pond to pump water, and the other end returns water to the growing pond for aeration; and one end of the safety pipe is connected to the growing pond, and the other end is at the same level as the water-level safety line and is connected to the collection pond.

Further, the recycling device is provided with a recycling pond, which is an aerobic circulating treatment pond with a conical bottom; a fourth pump is disposed outside the recycling pond; the bottom of the recycling pond is connected to one end of the fourth pump through a discharge pipe, and the other end of the fourth pump is discharge into the recycling pond.

The utility model has the following advantageous effects:

solid sediments and soluble organic matters generated in the aquaculture process are separated, and the water quality is monitored in real time and treated in time to ensure that the aquaculture water is purified to meet the standard for circulating water supply, thereby improving the breeding survival rate, and aerobic recycling treatment is performed to the separated organic matters to reduce their harm to the environment.

### BRIEF DESCRIPTION OF THE DRAWINGS

FIG. 1 is a structural schematic diagram of a preferred embodiment of an online circulating water purification system according to the utility model;

FIG. 2 is a flowchart of the preferred embodiment of the online circulating water purification system according to the utility model;

FIG. 3 is a structural schematic diagram of a preferred embodiment of an anti-blocking aeration device in FIG. 1;

FIG. 4 is a structural schematic diagram of a preferred embodiment of a water purification and separation system in FIG. 1;

FIG. 5 is a flowchart of the preferred embodiment of a recycling device in FIG. 1; and

FIG. 6 is a flowchart of a preferred embodiment of a water quality monitoring device of the online circulating water purification system according to the utility model.

Reference numerals: 1 feeding machine; 2 growing pond; 201 water-level safety line; 202 mesh; 203 first discharge pipe; 3 water purification and separation system; 4 recycling device; 401 recycling pond; 402 fourth pump; 5 collection pond; 501 first pump; 6 buffering pond; 7 sedimentation pond; 8 water purifier; 801 second pump; 802 third pump; 9 water quality monitoring device; 901 water quality monitor; 902 water quality detection element; 903 water quality regulating compartment; 10 anti-blocking aeration device; 101 anti-blocking device; 102 aeration pump; 103 safety pipe.

### DETAILED DESCRIPTION OF THE INVENTION

The utility model is further described below with reference to the accompanying drawings and embodiments.

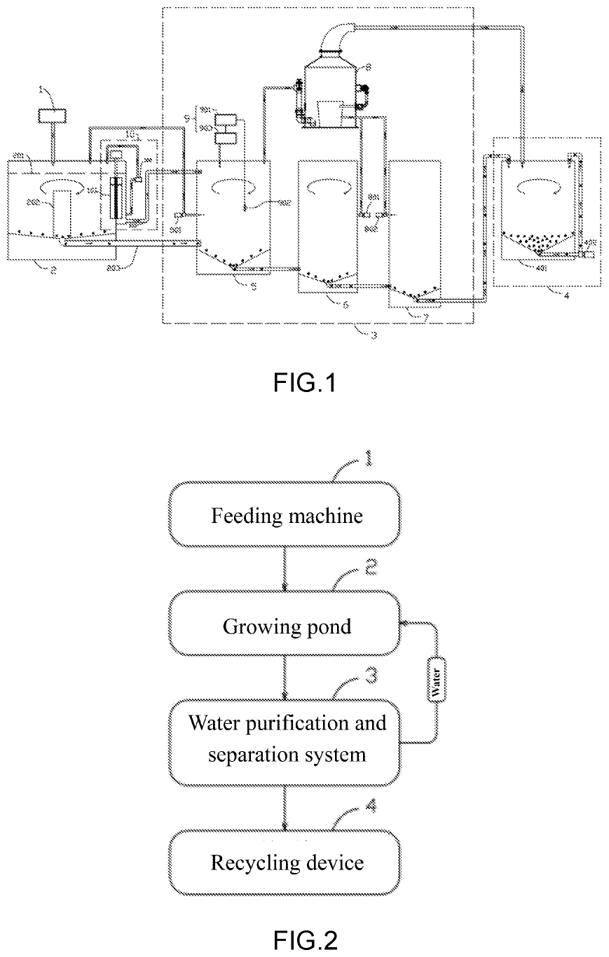

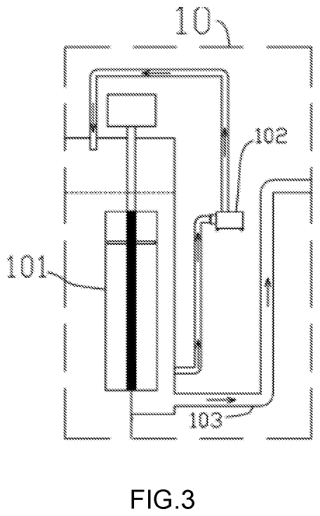

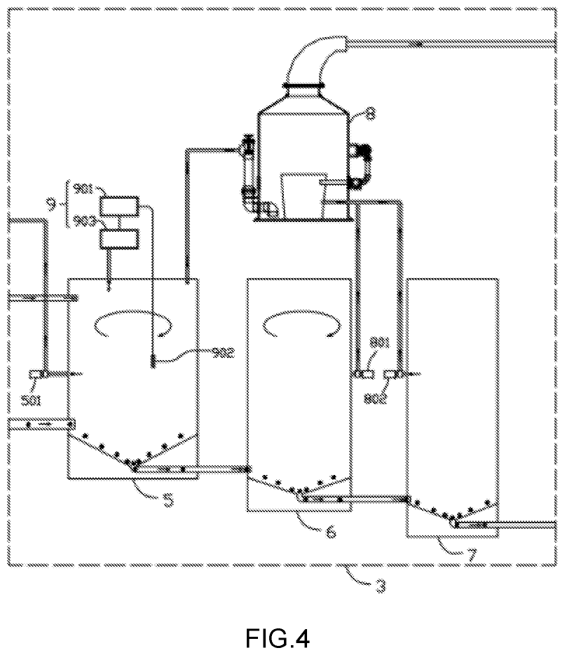

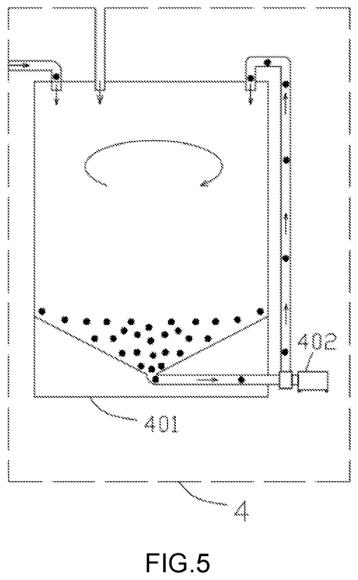

As shown in FIGS. 1-5, an online circulating water purification system for aquaculture includes a feeding machine 1, a growing pond 2, a water purification and separation system 3, and a recycling device 4, where the feeding machine 1 for feeding fry to the growing pond 2 is dispose outside the growing pond 2, the upper part of the growing pond 2 is provided with a water-level safety line 201, an anti-blocking aeration device 10 is mounted in the growing pond 2, the bottom of the growing pond 2 is conical, and a mesh 202 for filtering solids from liquids is mounted at the bottom of the growing pond 2; the bottom of the growing pond 2 is connected to the water purification and separation system 3 through a first sewage pipe 203; the water purification and separation system 3 is provided with a first pump 501; the first pump 501 is connected to the water purification and separation system 3 through a pipeline to pump water to the growing pond 2 to form circulating water, and the water purification and separation system 3 is connected to the recycling device 4.

The specification and shape of the growing pond 2 are set according to the breeding scale, and its shape includes, but not limited to, round, square, trapezoid or polygon, and the bottom of the growing pond 2 is of a conical structure.

The mesh 202 is preferably a vertical mesh to filter the solid sediments (for example, feces and residual bait) in the growing pond 2, and the activity space at the bottom of the growing pond 2 is enlarged to improve the activity rate of the breeding organisms.

In this embodiment, the water in the growing pond 2 is flowable and flows in one direction (for example, the oval arrow in the drawings).

In one embodiment, by using the feeding machine 1 to regularly feed fodders to the growing pond 2 for the breeding organisms (for example, fish, shrimp, crab, etc.), a large amount of solid sediments such as feces and feeds produce in the breeding process is filtered through the mesh 202, and the tiny solid sediments pass through the first sewage pipe 203 at the bottom into the water purification and separation system 3 to be treated, and then the water meeting the water quality standard is pumped by the first pump 501 back to the growing pond 2, so that the water in the growing pond 2 can be circulated, thereby saving water. The generated solid sediments, soluble organic matters, ammonia nitrogen, etc. are discharged into the recycling device 4 by the water purification and separation system 3. The aerobic circulating treatment is performed on the solid sediments, soluble organic matters and ammonia nitrogen by the recycling device 4, thereby avoiding directly discharging to harm the environment.

Further, the water purification and separation system 3 includes a collection pond 5, a buffer pond 6, a sedimentation pond 7, a water purifier 8, and a water quality monitoring device 9. The bottoms of the collection pond 5, buffering pond 6, and sedimentation pond 7 are all conical. The bottom of the collection pond 5 is connected to the buffer pond 6 through a discharge pipe, the bottom of the buffer pond 6 is connected to the sedimentation pond 7 through a discharge pipe, and the bottom of the sedimentation pond 7 is connected to the recycling device 4 through a discharge pipe. The collection pond 5 is connected to the first discharge pipe 203 at the bottom of the growing pond 2. The water quality monitoring device 9 is mounted outside the collection pond 5. The collection pond 5 is connected to the water quality monitoring device 9. The water purifier 8 is mounted at one side of the water quality monitoring device 9. The water purifier 8 is connected to the collection pond 5, buffer pond 6, sedimentation pond 7 and recycling device 4.

The water purification and separation system 3 is a multifunctional system. The solid sediments are separated one by one by using the collection pond 5 and the buffer pond 6, and are then precipitated by the sedimentation pond 7 before discharge into the recycling device 4 for treatment. In the separation process, the water quality in the collection pond 5 is monitore, and is treated in time (for example, water quality neutralization). The water purification and separation system 3 also uses the water purifier 8 to draw the water in the buffer pond 6 and sedimentation pond 7 for purification, the purified water is discharge into the collection pond 5 for treatment and then is pump to the growing pond 2. By using the water purification and separation system 3, the water breeding environment of the growing pond 2 is guaranteed, and moreover, the indiscriminate discharge harming the environment is avoided.

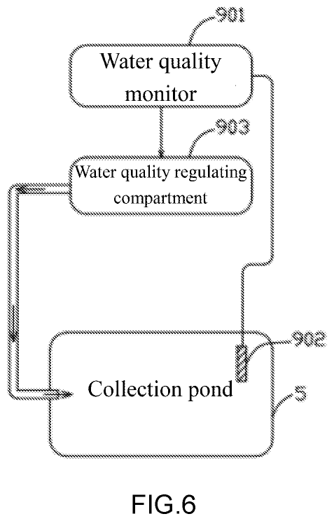

Further, as shown in FIG. 6, the water quality monitoring device 9 includes a water quality monitor 901, a water quality detection element 902, and a water quality regulating compartment 903. The water quality detection element 902 is mounted in the collection pond 5. The water quality regulating compartment 903 is disposed at one side of water quality monitor 901. The water quality monitor 901 is connected to the water quality detection element 902 and the water quality regulating compartment 903. The water quality regulating compartment 903 is connected to the collection pond 5 through a pipeline, and inputs a conditioning agent to the collection pond 5.

In one embodiment, when the water quality detection element 902 detects that the ammonia nitrogen content of the water in the collection pond 5 exceeds a set safety threshold, the water quality monitor 901 will obtain the data detected by the water detection element 902, and then control the water quality regulating compartment 903 to convey a carbon source to the collection pond 5, and the microorganisms in the aquaculture water degrades the ammonia nitrogen in the water using the carbon source. When the water quality detection element 902 detects that the ammonia nitrogen content of the water in the collection pond 5 is within the safety threshold, the water quality monitor 901 will control the water quality regulating compartment 903 to stop conveying the carbon source.

In another embodiment, when the water quality detection element 902 detects that the calcium content of the water in the collection pond 5 is insufficient, the water quality monitor 901 will obtain the data detected by the water quality detection element 902, and then control the water quality regulating compartment 903 to convey calcium to the collection pond 5. When the water quality detection element 902 detects that the calcium content of the water in the collection pond 5 reaches a predetermined value, the water quality monitor 901 will control the water quality regulating compartment 903 to stop conveying the calcium.

Further, a second pump 801 and a third pump 802 are disposed outside the water purifier 8. The second pump 801 is connected to the buffer pond 6 to pump water to the water purifier 8 for purification. The third pump 802 is connected to the sedimentation pond 7 to pump water to the water purifier 8 for purification. Water purified by the water purifier 8 is convey to the collection pond 5 through a bottom pipeline. Gas generated in the purification of the water purifier 8 is conveyed to the recycling device 4 through a top pipeline.

In one embodiment, the dirty water of the buffer pond 6 and sedimentation pond 7 is respectively pump into the water purifier 8 by the second pump 801 and the third pump 802 for purification. After the dirty water is purified, the purified water after the purification is convey to the collection pond 5. During the purification treatment, the generated foam-like separated matters (the soluble organic matters, etc.) are discharge into the recycling device 4 to avoid harming the environment.

Further, the anti-blocking aeration device 10 includes an anti-blocking device 101, an aeration pump 102, and a safety pipe 103. The anti-blocking device 101 is disposed inside the growing pond 2, and the aeration pump 102 is located outside the growing pond 2. One end of the aeration pump 102 is connected to the growing pond 2 to pump water, and the other end returns water to the growing pond 2 for aeration. One end of the safety pipe 103 is connected to the growing pond 2, and the other end is at the same level as the water-level safety line 201 and is connected to the collection pond 5.

In one embodiment, if the mesh 202 is blocked by the solid sediments, the water level in the growing pond 2 starts to rise, and when the water reaches the water-level safety line 201, the water pressure in the growing pond 2 will be higher than that in the safety pipe 203, and then water in the growing pond 2 will be discharged into the collection pond 5 through the safety pipe 203, and moreover, the anti-blocking device 101 will be operated to increase the water fluidity of the growing pond 2, to eliminate the blocked object on the mesh 202, so that the water level in the growing pond 2 will be returned under the water-level safety line 201.

Further, said recycling device 4 is provided with a recycling pond 401, which is an aerobic circulating treatment pond with a conical bottom. A fourth pump 402 is disposed outside said recycling pond 401. The bottom of said recycling pond 401 is connected to one end of the fourth pump 402 through a discharge pipe, and the other end of said fourth pump 402 is discharge into the recycling pond 401.

Said recycling pond 401 receives the solid sediments, soluble organic matters, ammonia nitrogen, and the like, and the harmful substances such as solid sediments, soluble organic matters, and ammonia nitrogen are eliminated by a preset aerobic circulating treatment.

In this embodiment, the solid sediments treated by the recycling pond 401 are discharge through a sewage passage switch (not shown) disposed at the bottom in advance.

In one optional embodiment, the treated solid sediments are subjected to waste utilization, and are processed by means of separation, purification, extraction and the like to obtain, for example, feed additives, bacterial culture media and organic fertilizers.

Those skilled in the art can also make appropriate changes and modifications to the foregoing embodiments according to the disclosure and instruction of the specification above Therefore, the utility model is not limited to the specific embodiments disclosed and described above, and the modifications and changes of the utility model should also fall within the protection scope of the appended claims of the utility model In addition, although some specific terms are used in the specification, they are merely for the convenience of description, and shall not pose any limit to the utility model.

What is claimed is:

1. A circulating water purification system for aquaculture breeding, comprises a feeding machine, a growing pond, a water purification and separation system, and a recycling device, wherein the feeding machine for feeding fry to the growing pond is disposed outside the growing pond, the upper part of the growing pond is provided with a water-level safety line, an anti-blocking aeration device is mounted in the growing pond, the bottom of the growing pond is conical, and a mesh for filtering solids from liquids are mounted at the bottom of the growing pond; the bottom of the growing pond is connected to the water purification and separation system through a sewage pipe; the water purification and separation system are provided with a feed pump; the feed pump is connected to the water purification and separation system through a pipeline to pump water to the growing pond to form circulating water, and the water purification and separation system is connected to the recycling device.

2. The circulating water purification system for aquaculture according to claim 1, characterized in that the water purification and separation system comprises a collection pond, a buffering pond, a sedimentation pond, a water purifier, and a water quality monitoring device; the bottom of the collection pond, buffering pond, and sedimentation pond are all conical, the bottom of the collection pond is connected to the buffering pond through a discharge pipe, the bottom of the buffering pond is connected to the sedimentation pond through a sewage pipe, and the bottom of the sedimentation pond is connected to the recycling device through a discharge pipe; the collection pond is connected to the discharge pipe at the bottom of the growing pond; the water quality monitoring device is mounted outside the collection pond; the collection pond is connected to the water quality monitoring device; the water purifier is mounted at one side of the water quality monitoring device; and the water purifier is connected to the collection pond, buffering pond, sedimentation pond and recycling device.

3. The circulating water purification system for aquaculture breeding according to claim 2, characterized in that the water quality monitoring device comprises a water quality monitor, a water quality detection element, and a water quality regulating compartment, the water quality detection element is mounted in the collection pond, the water quality regulating compartment is disposed at one side of the water quality monitor; the water quality monitor is connected to the water quality detection element and the water quality regulating compartment; and the water quality regulating compartment is connected to the collection pond through a pipeline, and inputs a conditioning agent to the collection pond.

4. The circulating water purification system for aquaculture according to claim 2, characterized in that a second pump and a third pump are dispose outside the water purifier; the second pump is connected to the buffer pond to pump water to the water purifier for purification; the third pump is connected to the sedimentation pond to pump water to the water purifier for purification; water purified by the water purifier is conveyed to the collection pond through a bottom pipeline; and a foam-like separated matter generated in the purification of the water purifier is convey to the recycling device through a top pipeline.

5. The circulating water purification system for aquaculture according to claim 1, characterized in that the anti-blocking aeration device comprises an anti-blocking device, an aeration pump, and a safety pipe, the anti-blocking device is disposed inside the growing pond, and the aeration pump is located outside the growing pond; one end of the aeration pump is connected to the growing pond to pump water, and the other end returns water to the growing pond for aeration; and one end of the safety pipe is connected to the growing pond, and the other end is at the same level as the water-level safety line and is connected to the collection pond.

6. The circulating water purification system for aquaculture according to claim 1, characterized in that the recycling device is provided with a recycling pond, which is an aerobic circulating treatment pond with a conical bottom, a fourth pump is disposed outside the recycling pond; the bottom of the recycling pond is connected to one end of the fourth pump through a discharge pipe, and the other end of the fourth pump is discharged into the recycling pond.
